(19) United States
(12) Patent Application Publication
(10) Pub. No.: US 2012/0311900 A1
(43) Pub. Date: Dec. 13, 2012

(54) SCROLL SYSTEM AND METHOD

(76) Inventor: William Andrews, San Carlos, CA (US)

(21) Appl. No.: 13/157,329

(22) Filed: Jun. 10, 2011

(51) Int. Cl. G09F 19/00; B65H 39/00

(52) U.S. Cl. 40/533; 270/58.17

(57) ABSTRACT

A scroll system and method. The scroll system includes a core that has two end walls that are preferably disc-shaped. A slot that detachably couples a stack of writing material is disposed within the core. The writing materials need not be accessed sequentially but are randomly accessible. The writing materials are also rollable around the core and can be unwound from said core for use.

### BACKGROUND OF THE INVENTION

The present invention relates generally to scroll systems and methods and more specifically to scroll systems and methods for documenting messages, text and other important communication.

Scrolls are known to have originated over 2,000 years ago. According to Jewish doctrine, Moses employed a scroll for copying the Torah in its entirety. Well known Dead Sea Scrolls also recorded hundreds of texts of the Hebrew Bible. Thus, scrolls have always been important and have served to keep some of the most significant records in human history.

A scroll is a single piece of papyrus or parchment that can be rolled. Some can be rolled from side to side or from top to bottom. A common feature of many scrolls is that they are sequential. That is, the visible page is rolled up so that the next page can be viewed.

Regardless of their ancient underpinnings, scrolls evoke connotations of importance. Messages carried by scrolls can be regarded as important just as the ancient scroll records remain relevant even in today's world.

It is within the aforementioned context that a need arises for the present invention, and the present invention meets this need.

### BRIEF SUMMARY OF THE INVENTION

Various aspects of a method and system for communicating information can be found in exemplary embodiments of the present invention.

In a first embodiment, the scroll system includes an elongated core capped at both ends by two end walls. This core includes a longitudinally disposed slot wherein a stack of writing materials is detachably coupled at one end. The other end of the stack remains free and undetached so that the writing materials are randomly accessible unlike conventional scrolls that require sequential access. Clockwise or counterclockwise rotation of the core produces a rotational movement that either rolls or unrolls the writing material stack around or from the core. The rolled-up writing material may be inserted into a cover for storage.

A further understanding of the nature and advantages of the present invention herein may be realized by reference to the remaining portions of the specification and the attached drawings. Further features and advantages of the present invention as well as the structure and operation of various embodiments of the present invention are described in detail below with respect to the accompanying drawings. In the drawings, the same reference numbers indicate identical or functionally similar elements.

### BRIEF DESCRIPTION OF THE DRAWINGS

FIG. 1 illustrates a scroll system according to an exemplary embodiment of the present invention.

FIG. 2 illustrates in more detail the writing material of FIG. 1 according to an exemplary embodiment of the present invention.

FIG. 3 is a front elevational view of the core of FIG. 1 in accordance with an exemplary embodiment of the present invention.

FIG. 4 illustrates a side elevational view of the core and the end wall of FIG. 1 and FIG. 3 according to an exemplary embodiment of the present invention.

FIG. 5 illustrates scroll system 500 according to an exemplary embodiment of the present invention.

FIG. 6 illustrates scroll system 600 according to an exemplary embodiment of the present invention.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

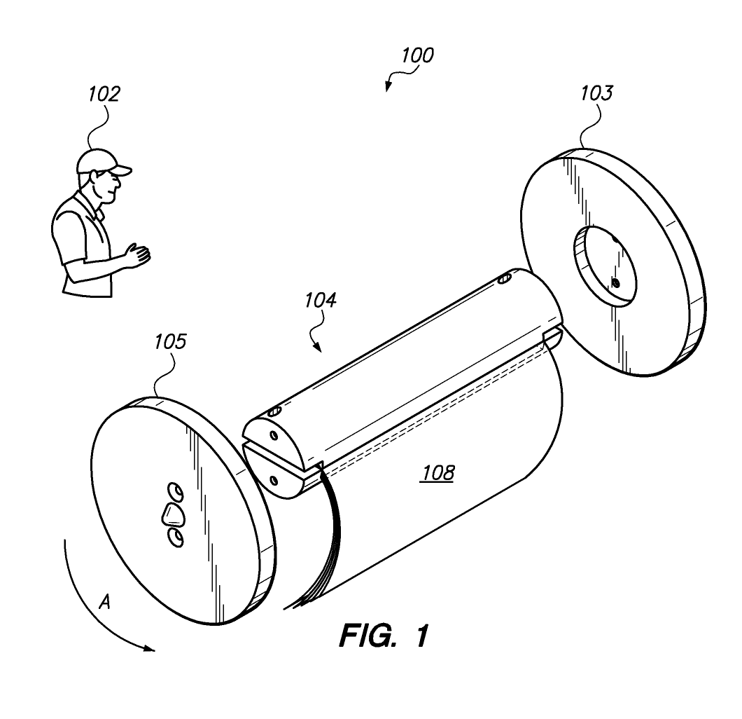

FIG. 1 illustrates scroll system 100 according to an exemplary embodiment of the present invention.

In FIG. 1, user 102 might employ scroll system 100 for conveying information, particularly communication considered important by the user. As an example, user 102 might be a parent with young children. Wishing to instill virtues in such young children, user 102 might then employ scroll system 100 to deliver written or printed communication about virtues.

Scroll system 100 itself connotes to recipients that received messages are important. This is but an example of the functionality of the present invention. Messages communicated need not connote importance, and other uses consistent with the spirit and scope of the present invention may be utilized.

In FIG. 1, scroll system 100 comprises core 104 capped by end walls 103 and 105. Core 104 is itself detachably coupled to writing material 108. As shown, writing material 108 extends downwardly from core 104 and is rollable around core 104 in the direction depicted by arrow A.

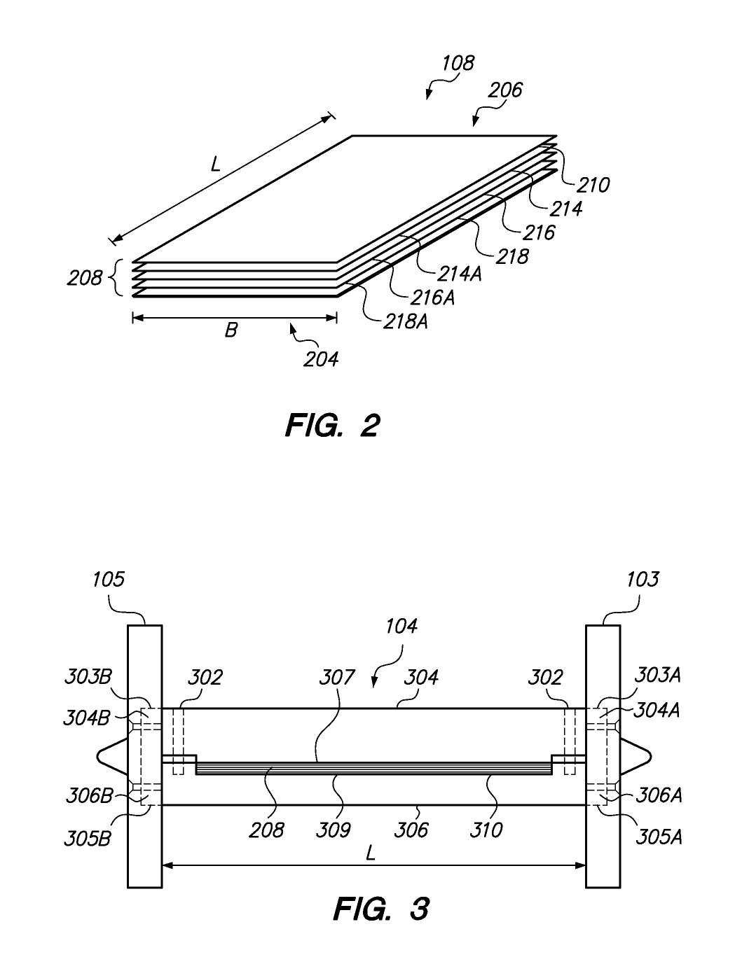

FIG. 2 illustrates in more detail writing material 108 according to an exemplary embodiment of the present invention.

In FIG. 2, writing material 108 is shown as stack 208 that includes a plurality of writing materials. Specifically, stack 208 includes writing material pieces 214, 216 and 218. Preferably, the number of writing material pieces ranges from three to 1,000 pieces. It is further preferred that this range is between 25 to 50 pieces.

Here, each writing material of stack 208 might be formed from parchment, papyrus, paper or any material consistent with the spirit and scope of the present invention. Preferably, Bible paper or lightweight offset paper which is a type of wood-free, uncoated paper can be used. This paper type has the advantage of being lightweight and thin containing cotton or linen fibers to increase its strength despite its thinness.

In FIG. 2, the writing materials include distal end 206 and proximate end 204. All of the writing material edges are aligned at both proximate end 204 and distal end 206. Specifically, the writing materials are stacked one above the other so that their edges are aligned. For example, writing material 214, writing material 216 and writing material 218 are stacked so that edge 214A of writing material 214 and edge 216A of writing material 216 and edge 218A of writing material 218 are aligned with each other.

It is preferred that uppermost writing material 210 placed above all of the other writing materials be comprised of a leather-type material or one that is heavier relative to writing materials 214, 216 and 218. In this manner, not only can uppermost writing material 210 function as a cover, it can also ease rolling of stack 208/writing material 108 around core 104 (FIG. 1).

Note that the weight, thickness and flexibility of each writing material are such that stack 208 can be wound on core 104. Thus, relatively stiff and inflexible cardboard material is not contemplated for use with the present invention.

In FIG. 2, each writing material of stack 208 has similar dimensions. A preferred dimension is a length L of 8 to 10 inches and a breadth B of 4 to 4.25 inches. Other sizes consistent with the spirit and scope of the present invention can be utilized, such sizes depending upon the length L₁ of core 104 (FIG. 3).

FIG. 3 is a front elevational view of core 104 of FIG. 1 in accordance with an exemplary embodiment of the present invention.

In FIG. 3, in one embodiment, core 104 is arcuately shaped and elongated extending longitudinally from end wall 103 to end wall 105. Core 104 might be made of elastomeric material, hard polyurethane, wood or other materials consistent with the spirit and scope of the present invention.

Preferably, core 104 comprises two and separate distinct cores, namely upper core 304 and lower core 306, each of upper core 304 and lower core 306 being spaced apart so as to accommodate stack 208 there between. Each of upper core 304 and lower core 306 are semi-arcuately shaped and elongated as well, extending from end wall 103 to end wall 105.

As can be seen, lower core 306 is aligned with and disposed below upper core 304. Each end of upper core 304 projects sidewardly into tongue 304A and 304B. Tongue 304A is received by a corresponding groove 303A formed within end wall 103. Similarly, tongue 304B is received by corresponding groove 303B formed within end wall 105. As shown, upper core 304 also includes aperture 302 for receiving a fastener disposed to couple upper core 304 and lower core 306 when stack 208 is disposed therein between.

Each end of lower core 306 projects sidewardly to form at its ends tongue 306A and tongue 306B oppositely disposed from tongue 306A. Tongue 306A is received by groove 305A formed within end wall 103 while tongue 306B is received by groove 305B formed within end wall 105. In this manner, core 104 is coupled to end wall 103 and end wall 105 each of which can be manipulated so as to roll or unroll stack 208 of writing material 108 (FIGS. 1 and 2).

An exemplary length L₁ of core 104 is 6 inches. Thus, corresponding writing material 108 should preferably be no more than 4 inches wide. As shown, each end wall 105 and end wall 103 is disc-shaped although other shapes consistent with the spirit and scope of the present invention can be utilized. Core 104 is disposed centrally between end wall 103 and end wall 105. Exemplary thickness of each of the end walls is 0.5 inches.

In FIG. 3, lower core 306 includes slot 310 for receiving stack 208. As can be seen, slot 310 extends longitudinally almost the full length of lower core 306. Slot 310 does not fully extend sideways to the end walls so as to allow for aperture 302 that receives fasteners for attaching both cores. Slot 310 is formed on upper surface 309 of lower core 306 which surface serves as a supporting base for receiving stack 208.

Slot 310 has no upper periphery so that additional pieces of writing material 108 can be added until such that the uppermost writing material material and lower surface 307 of upper core 304 are in contact. The fastener via aperture 302 can then be tightened until upper core 304 is firmly in contact with stack 208 which is then sandwiched between upper core 304 and lower core 306.

Note that end wall 103 and end wall 105 can be made of substantially the same material as core 104. Although core 104 has been illustrated as two separate cores, one skilled in the art will realize that the present invention is amenable by using a single core further described in an alternate embodiment of the present invention.

Although not shown, another method of fastening core 104 and end walls 103, 105 can be utilized. End walls 103, 105 may or may not be detachable from core 104 depending on individual preference.

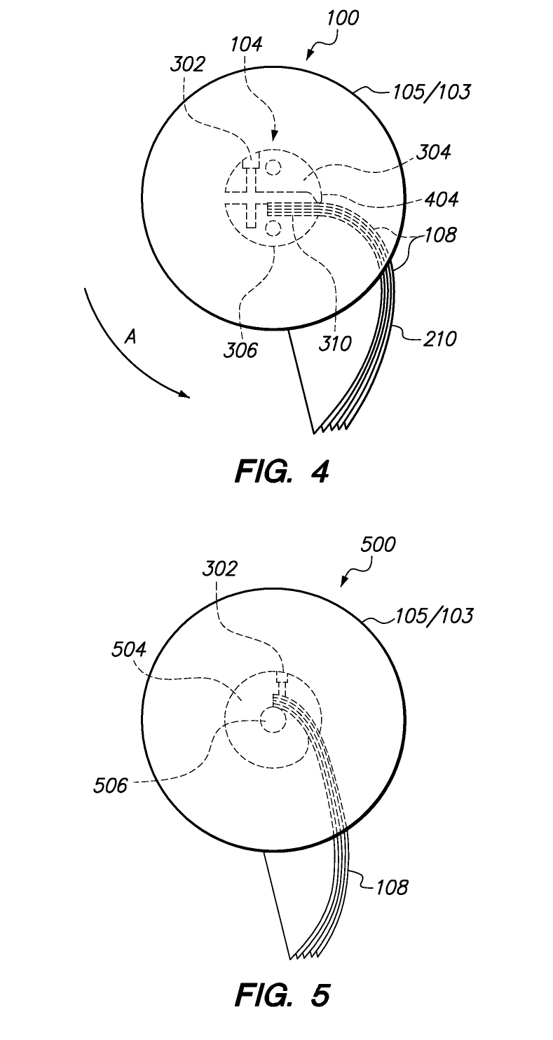

FIG. 4 illustrates a side elevational view of core 104 and end wall 105 of FIG. 1 and FIG. 3 according to an exemplary embodiment of the present invention.

In FIG. 4, core 104 is comprised of upper core 304 and lower core 306 as shown. As can be seen, core 104 is circular or tubular in cross section. Exemplary diameter of core 104 is 0.75 inches. Each of end walls 103 and 105 has an exemplary diameter of 1.75 inches.

As can be seen, writing material 108 extends in a downward direction and as either of walls 105 and 103 is manipulated in the direction A, writing material 108 is wound around core 104. An advantage of the present invention is that scroll system 100 includes bill 404 that is a curved lip that enables writing material 108 to fall and contour smoothly around core 104. Use and operation of scroll system 100 will now be described.

In operation, user 102 (FIG. 1) begins by inserting distal end 206 of stack 208 (FIG. 2) into slot 310. Additional writing material 108 can be stacked until the uppermost writing material is in contact with surface 307 of upper core 304.

Thereafter, user 102 can fasten a fastener via aperture 302 until stack 208 is firmly secured in place. User 102 is then free to utilize writing material 108 as deemed necessary. Each of writing material 108 might comprise printed materials or handwritten materials. Whether printed or handwritten, writing materials 108 can be automatically aligned and inserted into slot 310 by using a machine (not shown) as well as automatically fastened and secured in place.

Once stack 208 is in place, end wall 103 or 105 is manipulable and can be rotated in a clockwise or counterclockwise direction as appropriate in order to roll writing material 108 around core 104. Once rolled up, the rolled-up writing material 108 and core 104 can be inserted into a tubular cover (not shown) into which scroll system 100 is insertable. The tubular cover has a diameter that is essentially slightly more than the diameter of end wall 105.

Writing material 108 as noted might comprise printed or written materials, such as printed or written materials being words of wisdom, Bible quotations, messages for greeting cards, children's books and other important subject matter that needs to be transmitted to recipients. Specifically, scroll system 100 might be used to deliver favorite Biblical verses and citations to recipients.

It is noted that once the distal end of the writing material has been inserted into slot 310, the oppositely disposed end is undetached and free. Unlike conventional scrolls, each page or piece of writing material is randomly accessible, pages or materials can be flipped while core 104 acts as a fulcrum.

The first page can be accessed followed immediately by a tenth page for example since the distal ends of all the pages are unattached. In this manner, the present invention helps to convey important messages since the invention itself is a scroll system which itself connotes a sense of importance based on ancient traditions in history conveyed by scrolls in general.

Although the invention has been described with regard to embodiments, one of ordinary skill in the art will realize that the present invention is not limited to said embodiments.

For example, FIG. 5 illustrates scroll system 500 according to an exemplary embodiment of the present invention.

In FIG. 5, scroll system 500 is as described with reference to previous embodiments except that scroll system 500 is comprised of single core 504. Here, single core 504 is hollow having a chamber 506.

Chamber 506 can store materials that might be related to messages or communication transmitted by writing material 108. Information transmitted by writing material 108 can be for example a recipe for a particular type meal. In one embodiment, chamber 506 may contain appropriately measured amounts of dry spices (e.g. a premeasured pinch of salt, garlic spice, etc.) for the recipe. In this manner, the scroll system 500 embodiment can be transmitted as a single unit, and the intended recipient need not spend time attempting to gather all of the separate ingredients needed for the recipe.

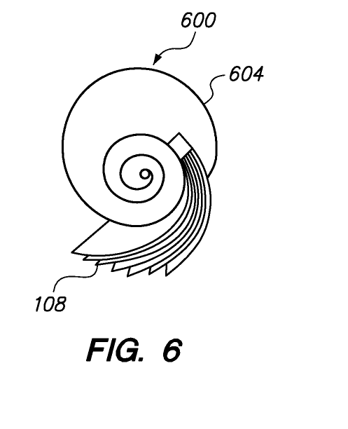

FIG. 6 illustrates scroll system 600 according to an exemplary embodiment of the present invention.

In FIG. 6, scroll system 600 is an open-ended rolled metal coil. Unlike previous embodiments described herein, scroll system 600 has no central core but is comprised of spring 604 that coils and uncoils in order to access writing materials 108.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A scroll system comprising:
a stack of writing materials ranging from at least three pieces of writing materials to one thousand pieces of writing material, each piece of writing material having similar dimensions and being stacked one above another so that edges of a first piece of writing material and edges of a second piece of writing material that is above or below the first piece of writing material are aligned; and
a slotted core extending longitudinally from a proximal to a distal end, wherein said slotted core is capped at each of said proximal and distal end by an end wall, wherein said slotted core includes a slot that is longitudinally disposed within said slotted core, wherein a proximate end of the stack of writing materials is inserted into said slot and is detachably fastened therein so that a distal end of said stack that is oppositely disposed to the proximate end remains undetached and free, wherein from said distal end of said stack, each piece of writing is randomly accessible and can be freely turned over while the slotted core acts as a fulcrum, wherein when said end wall is rotated in either a clockwise or counter clockwise direction, said at least three to one thousand pieces of writing materials of said stack are rolled and wound around the slotted core, said end walls keeping sides of said pieces of writing materials aligned as said at least three to one thousand pieces of writing materials are wound around the slotted core.

2. The system of claim 1 wherein the slotted core is comprised of two separate cores namely an upper core extending longitudinally between said end walls and a lower core wherein said lower core is disposed below the upper core and extends longitudinally between said end walls.

3. The system of claim 2 wherein said slot is disposed within the lower core.

4. The system of claim 3 wherein when said stack of writing material is detachably fastened and a lower surface of the upper core is in contact with an uppermost writing material on the stack of writing materials.

5. The system of claim 1 further comprising a hollow storage disposed within the slotted core.

6. The system of claim 5 wherein said hollow storage is elongated and extends in a longitudinal direction, wherein said hollow storage is capped at a proximate and distal ends by said end walls.

7. The system of claim 1 wherein said slotted core includes a curved bill that directs writing material smoothly around the slotted core.

8. A system comprising:
a stack of writing materials, each piece of writing material having similar dimensions and being stacked one above another so that edges of a first piece of writing material and edges of a second piece of writing material that is above or below the first piece of writing material are aligned; and
a slotted core extending longitudinally from a proximal to a distal end, wherein said slotted core is capped at each of said proximal and distal end by an end wall, wherein said slotted core includes a slot that is longitudinally disposed within said slotted core, wherein a proximate end of the stack of writing materials is inserted into said slot and is detachably fastened therein so that a distal end of said stack that is oppositely disposed to the proximate end remains undetached and free, wherein from said distal end of said stack, each piece of writing is randomly accessible and can be freely turned over while the slotted core acts as a fulcrum, wherein when said end wall is rotated in either a clockwise or counter clockwise direction, said stack of writing material is rolled and wound around the slotted core, said end walls keeping sides of said pieces of writing materials aligned as said stack of writing materials is wound around the slotted core.

9. The system of claim 8 wherein said slotted core includes a curved bill that directs writing material smoothly around the slotted core.

10. A machine-implemented method comprising:
stacking writing materials ranging from at least three pieces of writing materials to one thousand pieces of writing material, each piece of writing material having similar dimensions and being stacked one above another so that edges of a first piece of writing material and edges of a second piece of writing material that is above or below the first piece of writing material are aligned;
providing a slotted core extending longitudinally from a proximal to a distal end, wherein said slotted core is capped at each of said proximal and distal end by an end wall, wherein said slotted core includes a slot that is longitudinally disposed within said slotted core; and
inserting a proximate end of the stack of writing materials into said slot and detachably fastening therein said stack so that a distal end of said stack that is oppositely disposed to the proximate end remains undetached and free, wherein from said distal end of said stack, each piece of writing is randomly accessible and can be freely turned over while the slotted core acts as a fulcrum, wherein when said end wall is rotated in either a clockwise or counter clockwise direction, said at least three to one thousand pieces of writing materials of said stack are rolled and wound around the slotted core, said end walls keeping sides of said pieces of writing materials aligned as said at least three to one thousand pieces of writing materials are wound around the slotted core.

11. The method of claim 10 further comprising providing a hollow storage within said slotted core.
